(19) United States
(12) Patent Application Publication
(10) Pub. No.: US 2009/0096219 A1
(43) Pub. Date: Apr. 16, 2009

(54) ENERGY GENERATION APPARATUS AND METHODS BASED UPON MAGNETIC FLUX SWITCHING

(76) Inventors: Ted Annis, Ann Arbor, MI (US); J. Patrick Eberly, Cincinnati, OH (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/244,278

(22) Filed: Oct. 2, 2008

Related U.S. Application Data
(63) Continuation-in-part of application No. 11/735,746, filed on Apr. 16, 2007.
(60) Provisional application No. 60/792,602, filed on Apr. 17, 2006.
(60) Provisional application No. 60/792,596, filed on Apr. 17, 2006.
(60) Provisional application No. 60/792,594, filed on Apr. 17, 2006.
(60) Provisional application No. 60/792,595, filed on Apr. 17, 2006.
(60) Provisional application No. 60/977,757, filed on Oct. 5, 2007.

(51) Int. Cl. F03G 7/00

(52) U.S. Cl. 290/1 R

(57) ABSTRACT

In an electrical energy generator, at least one permanent magnet generates flux and a magnetizable member forms the single flux path. An electrically conductive coil is wound around the magnetizable member, and a plurality of flux switches are operative to sequentially reverse the flux from the magnet through the member, thereby inducing electrical current in the coil. A “Figure-8” construction comprises two continuous loops of magnetizable material sharing a magnetizable member common to both loops. An alternative configuration uses stacked loops and a separate piece of material acting as the magnetizable member. One end of the magnet is coupled to one of the loops, with the other end being coupled to the other loop. Each loop further includes two flux switches operated in a 2×2 sequence to sequentially reverse the flux through the magnetizable member. A relatively small amount of electrical power is used to control the magnetic flux of a permanent magnet by switching the flux between alternate paths. The resulting power from the switched magnetic flux yields substantially more power than the power required for the input switching.

### REFERENCE TO RELATED APPLICATIONS

This application claims priority from U.S. Provisional Patent Application Ser. No. 60/977,757, filed Oct. 5, 2007. This application is also a continuation-in-part of U.S. patent application Ser. No. 11/735,746, filed Apr. 16, 2007, which claims priority from U.S. Provisional Patent Application Ser. Nos. 60/792,602; 60/792,596; 60/792,595; 60/792,594, all filed Apr. 17, 2006. The entire content of each application is incorporated herein by reference.

### FIELD OF THE INVENTION

This invention relates generally to energy generation and, in particular, to methods and apparatus wherein magnetic flux is switched through a flux path to produce electricity.

### BACKGROUND OF THE INVENTION

Magnetic flux may exist in “free-space,” in materials that have the magnetic characteristics of free-space, and in materials with magnetically conductive characteristics. The degree of magnetic conduction in magnetically conductive materials is typically indicated with a B-H hysteresis curve, by a magnetization curve, or both.

Permanent magnets may now be composed of materials that have a high coercively (Hc), a high magnetic flux density (Br), a high magneto motive force (mmf), a high maximum energy product (BHmax), with no significant deterioration of magnetic strength over time. An example is the NdFeB permanent magnet from VAC of Germany, which has an Hc of 1,079,000 Amperes/meter, a Br of 1.427 Tesla, an mmf ranging up to 575,000 Ampere-turns, and a BHmax of 392,000 Joules/meter³.

According to Moskowitz, “Permanent Magnet Design and Application Handbook” 1995, page 52, magnetic flux may be thought of as flux lines which always leave and enter the surfaces of ferromagnetic materials at right angles, which never can make true right-angle turns, which travel only in straight or curved paths, which follow the shortest distance, and which follow the path of lowest reluctance (resistance to magneto motive force).

Free space presents a high reluctance path to magnetic flux. There are many materials that have the magnetic characteristics similar to those of free space. There are other materials that offer a low or lower reluctance path for magnetic flux, and it is these materials that typically comprise a defined and controllable magnetic path.

High-performance magnetic materials for use as magnetic paths within a magnetic circuit are now available and are well suited for the (rapid) switching of magnetic flux with a minimum of eddy currents. Certain of these materials are highly nonlinear and respond to a “small” applied magneto motive force (mmf) with a robust generation of magnetic flux (B) within the material. The magnetization curves of such materials show a high relative permeability (ur) until the “knee of the curve” is reached, at which point ur decreases rapidly approaching unity as magnetic saturation (Bs) is reached.

Certain of these nonlinear, high-performance magnetic materials are characterized as “square” due to the shape of their B-H hysteresis curves. An example is the FINEMET® FT-3H nanocrystalline core material made by Hitachi of Japan. Other examples include Superperm49, Superperm80, SuperMalloy, SuperSquare80, Square50, and Supermendur, which are available from Magnetic Metals in the USA.

A “reluctance switch” is a device or means that can significantly increase or decrease (typically increase) the reluctance of a magnetic path. This is ideally done in a direct and rapid manner, while allowing a subsequent restoration to the previous (typically lower) reluctance, also in a direct and rapid manner. A reluctance switch typically has analog characteristics. By way of contrast, an off/on electric switch typically has a digital characteristic, as there is no electricity “bleed-through.” With the current state of the art, however, reluctance switches exhibit some magnetic flux bleed-through. Reluctance switches may be implemented mechanically, such as to cause keeper movement to create an air gap, or electrically by various other means.

One electrical reluctance switch implementation uses a control coil or coils wound around a magnetic path or a sub-member that affects the path. U.S. Navy publication, “Navy Electricity and Electronics Series, Module 8—Introduction to Amplifiers” September 1998, page 3-64 to 3-66 describes how to modulate alternating current by changing the reluctance of the entire primary magnetic path by these means, one of which is used in a saturable-core reactor and the other in a magnetic amplifier. Flynn, U.S. Pat. No. 6,246,561; Patrick et al., U.S. Pat. No. 6,362,718; Pedersen, U.S. Pat. No. 6,946,938; Marshall, and US Patent Application 2005/01256702-A1 all disclose methods and apparatus that employ this type of reluctance switch for switching magnetic flux from a stationary permanent magnet or magnets for the purpose of generating electricity (and/or motive force).

Another electrical means of implementing a reluctance switch is the placement within the primary magnetic path of certain classes of materials that change (typically increase) their reluctance upon the application of electricity. Another electrical means of implementing a reluctance switch is to saturate a sub-region of a primary magnetic path by inserting conducting electrical wires into the material comprising the primary magnetic path. Such a technique is described by Konrad and Brudny in “An Improved Method for Virtual Air Gap Length Computation,” in IEEE Transactions on Magnetics, Vol. 41, No. 10, October 2005.

Another electrical means of implementing a reluctance switch is described by Valeri Ivanov of Bulgaria on the web site www.inkomp-delta.com, shown in FIG. 1. An electric toroid 110 is inserted into a primary magnetic path (100), such that the primary magnetic path is divided into two sub-paths 110A and 110B. A net magnetic flux reduction effect in the primary magnetic path 100 results from the combination of the effects in the two sub-paths 110A and 110B, each of which results from different physics principles. In the first sub-path 110A, the magnetic flux generated by applying electrical current to the windings 110 around toroidal path 110 opposes and subtracts from its portion of the magnetic flux 103 received from the primary magnetic path 100 yielding a reduced magnetic flux, which is also further reduced by a decrease in the sub-path 110A's relative permeability thereby increasing the reluctance of the sub-path. In the second sub-path 110B, the magnetic flux generated by applying electrical current to the toroid windings 111 adds to its portion of the magnetic flux 103 received from primary magnetic path 100 yielding an increased net magnetic flux that approaches or exceeds the knee of the material's magnetization curve thereby reducing its relative permeability and increasing its reluctance.

### SUMMARY OF THE INVENTION

This invention is directed to methods and apparatus wherein magnetic flux is switched in direction and in intensity through a flux path to produce electricity. The apparatus broadly comprises at least one permanent magnet generating flux, a magnetizable member forming the flux path, an electrical conductor wound around the magnetizable member, and a plurality of flux switches operative to sequentially reverse the flux from the magnet through the member, thereby inducing electrical current in the coil.

The preferred embodiment includes first and second loops of magnetizable material. The first loop has four segments in order A, 1, B, 2, and the second loop has four segments in order C, 3, D, 4. The magnetizable member couples segments 2 and 4, and the permanent magnet couples segments 1 and 3, such that the flux from the magnet flows through segments A, B, C, D and the magnetizable member. Four magnetic flux switches are provided, each controlling the flux through a respective one of the segments A, B, C, D. A controller is operative to activate switches A-D and B-C in an alternating sequence, thereby reversing the flux through the segment and inducing electricity in the electrical conductor. The flux flowing through each segment A, B, C, D is substantially half of that flowing through the magnetizable member prior to switch activation.

The loops and magnetizable member are preferably composed of a nanocrystalline material exhibiting a substantially square BH intrinsic curve. Each magnetic flux switch adds flux to the segment it controls, thereby magnetically saturating that segment when activated. To implement the switches, each segment may have an aperture formed therethrough and a coil of wire wound around a portion of that segment and through the aperture. The controller may be at least initially operative to drive the switch coils with electrical current spikes.

The first and second loops may be toroidal in shape, and the loops may be spaced apart from one another, with A opposing C, 1 opposing 3, B opposing D and 2 opposing 4. The magnetizable member in this case is preferably a separate piece of material. Alternatively, the first and second loops may form a “Figure-8” shape, with the two loops intersecting to form the magnetizable member.

The permanent magnet(s) and the material comprising the magnetic paths are preferably proportioned such that the material through the common segment is at or slightly below its maximum relative permeability before the electrically conducting output coil is energized. In the preferred embodiments, the power resulting from the switched magnetic flux yields substantially more power than the power required for the input switching.

### BRIEF DESCRIPTION OF THE DRAWINGS

FIG. 1 is a drawing of prior art reluctance switch in the form of an electrical toroid inserted into a primary magnetic path;

FIG. 2 is a detail drawing of a reluctance switch according to the invention;

FIGS. 3A and 3B are detail drawings showing the use of four reluctance switches according to the invention;

FIG. 4 is a drawing that depicts a preferred embodiment of the invention;

FIG. 5 is a detail drawing an alternative reluctance switch according to the invention implemented through split laminations;

FIGS. 6A and 6B show the operation of an energy generator according to the invention;

FIG. 7A is an exploded view of a preferred energy generator construction;

FIG. 7B is a side view of the construction of FIG. 7A;

FIG. 8 is a simplified schematic diagram of components used to simulate the apparatus of the invention;

FIG. 9A is a diagram that shows the current delivered to one pair of flux switches in the simulation;

FIG. 9B is a diagram that shows the current delivered to the other set of flux switches in the simulation;

FIG. 10 shows the output of the simulation disclosed herein; and

FIG. 11 is a block diagram of a controller applicable to the invention.

### DETAILED DESCRIPTION OF THE INVENTION

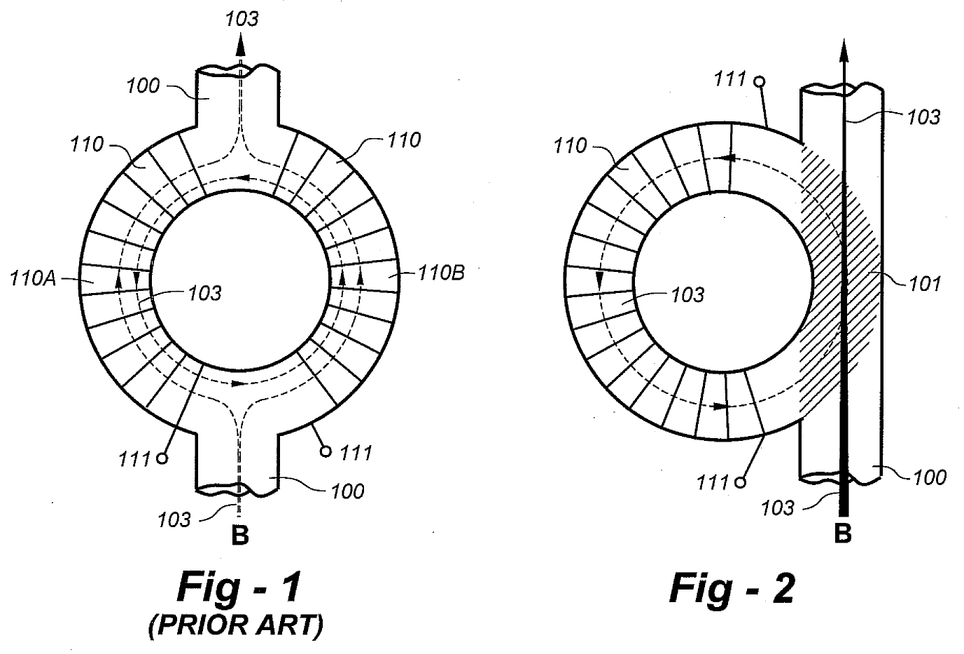

FIG. 2 is a detail drawing of a reluctance switch according to the invention. The reluctance switch includes the following components: a closed magnetic path 110 comprised of a high performance magnetic material (preferably a nonlinear material exhibiting a “sharp knee” as saturation is approached), around which is wound a coil 111. The closed magnetic path 110 shares common segment 101 with a primary magnetic path 100, in which magnetic flux 103 is induced by a permanent magnet (shown in subsequent drawings). Electric current is applied to windings 111 having a polarity and sufficient amperage so that the magnetic flux generated in the path of switch 110 is additive to the magnetic flux 103 from the permanent magnet, such that the primary path 110 approaches or reaches magnetic saturation.

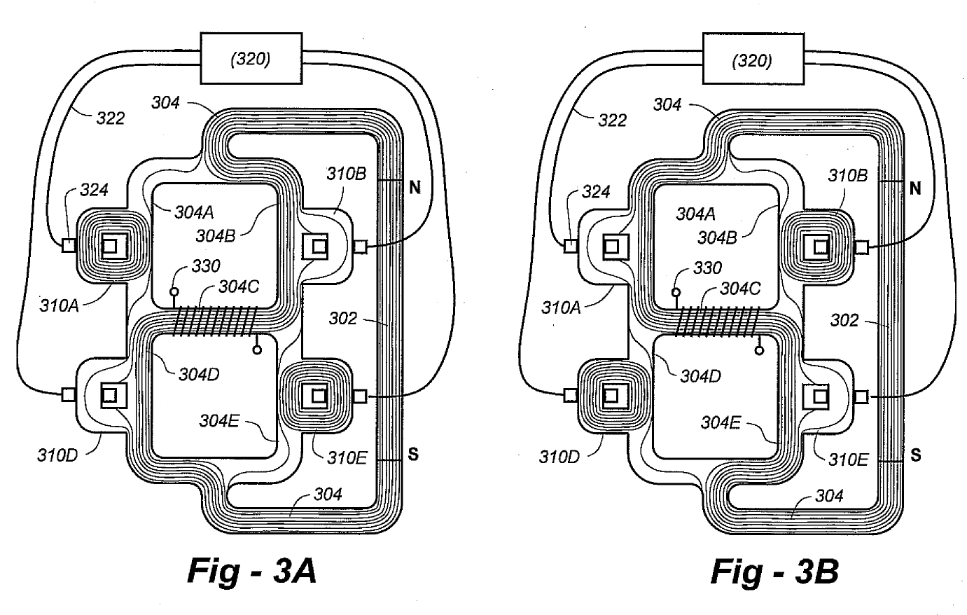

FIGS. 3A and 3B are detail drawings of apparatus that employs four reluctance switches according to the invention in a manner similar to that disclosed in U.S. patent application Ser. No. 11/735,746 entitled “Electricity Generating Apparatus Utilizing a Single Magnetic Flux Path,” the entire content of which is incorporated herein by reference. In this and in all embodiments described herein, the geometry of the closed magnetic paths may be circular (toroidal), rectangular, or any other closed-path shapes. A primary path 304 unidirectionally carries the flux from permanent magnet 302. Flux switch pairs 310A/E and 310 B/D are activated in alternating fashion to reverse the flux in magnetizable member 304C, thereby inducing electrical current in winding 330. FIG. 3A shows the flux flow in one direction, and FIG. 3B shows it reversed.

In FIG. 3A, switches 310A and 310E are activated by controller 320 in electrical communication with the windings on the switches such as through conductor 322 to winding 324. The additional flux in switches 310A and 310E are additive with the flux that would otherwise be present in segments 304A and 304E, thereby saturating these paths, causing the flux through segment 304C to be in the direction shown. In FIG. 3B, switches 310B and 310D are activated, saturating segments 304B and 304D, and reversing the flow.

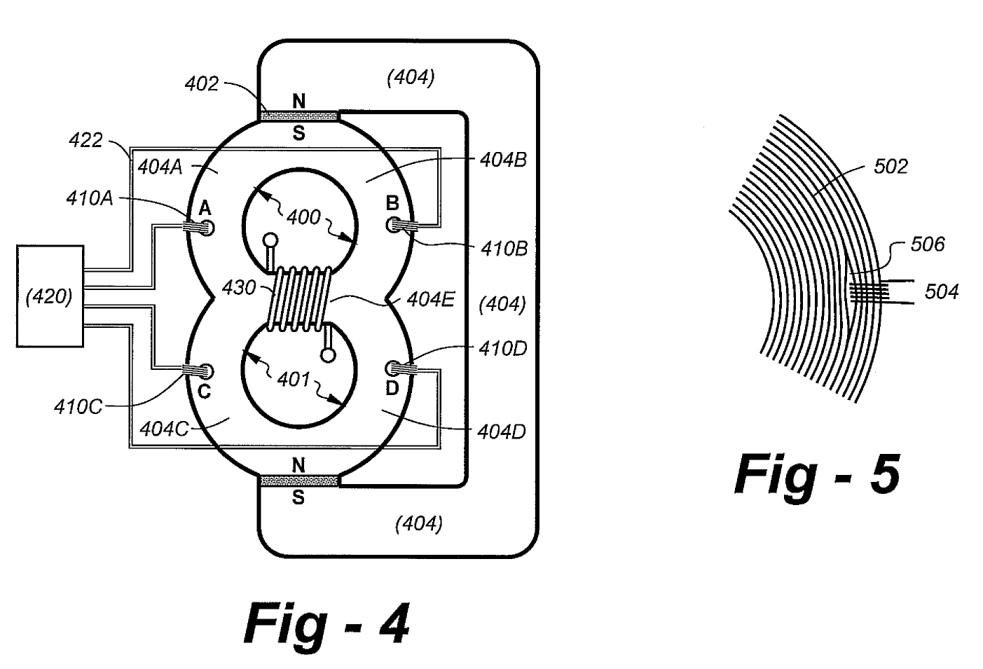

FIG. 4 is a drawing that depicts an embodiment of the invention using circular toroids 400, 401 and multiple permanent magnets 402, 403 disposed in the primary path 404. The two toroids 400, 401 intersect, forming magnetizable member 404E. A coil 430 is wound around the member 404E, as shown.

The primary magnetic path 404 interconnects the upper end of loop 400 and lower end of loop 401. One of the magnets, 402, couples one end of the primary magnetic path 404 to the first loop 400, and another, 403, couples the other end of the primary magnetic path 404 to the second loop 401.

In this and all of the embodiments described herein, the permanent magnets are strong, rare-earth magnets, and multiple magnets of any length (thickness) may be used in each case. Further in all embodiments, the loops, primary magnetic path and/or magnetizable member are preferably constructed from a high magnetic permeability material such as the FINEMET FT-3H nanocrystalline soft magnetic material available from Hitachi. The invention is not limited in this regard, however, as alternative materials, including laminated materials, may be used.

The connections of the primary magnetic path 404 to the two loops 400, 401 create four segments apart from magnetizable member 404E, the four segments including two opposing segments A, B in the first loop on either side of magnet 402, and two opposing segments C, D in the second loop on either side of magnet 403.

Four magnetic flux switches are provided, each being operative to control the flux through a respective one of the four segments. A controller 420 is operative to activate the switches associated with segments A and D, then B and C, in alternating fashion, thereby reversing the flux through the member 404E, thereby inducing electrical current in coil 430.

Apertures may be formed through each of the four segments, with the switches being implements with windings 410A-D through the apertures and around an outer (or inner) portion of each segment. As shown in FIG. 5, if the loops are fabricated with laminated material 502, the laminations may be split at 506 to accommodate coil 504. The percentage of the segment surrounded by the coil may vary in accordance with the material used, the waveforms presented to the coils, and other factors, with the goal being to magnetically saturate each segment through activation of the switch associated therewith, thereby reversing the flux through path 404E.

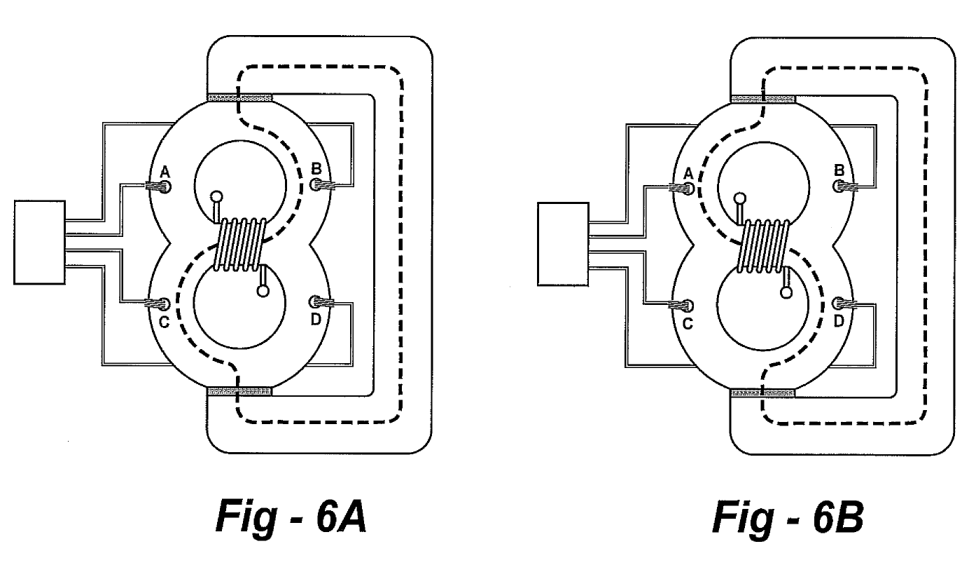

FIGS. 6A and 6B show the operation of the apparatus of FIG. 4. The primary path 404 unidirectionally carries the flux from permanent magnets 402, 403. Reluctance switches 410A-410D are activated in alternating fashion to reverse the flux in segment 404E which, in turn, induces electrical current in winding 430. FIG. 6A shows the flux flow in one direction, and FIG. 6B shows it reversed.

In FIG. 6A, switches 410A and 410D are activated by controller 420 in electrical communication with the windings on the switches, such as through conductors 422 to switch 410B. The flux provided by switches 410A and 410D, thereby saturating these paths, causing the flux through segment 404C to be in the direction shown. In FIG. 6B, switches 410B and 310C are activated, saturating segments 404B and 404D, thereby reversing the flux through path 404E.

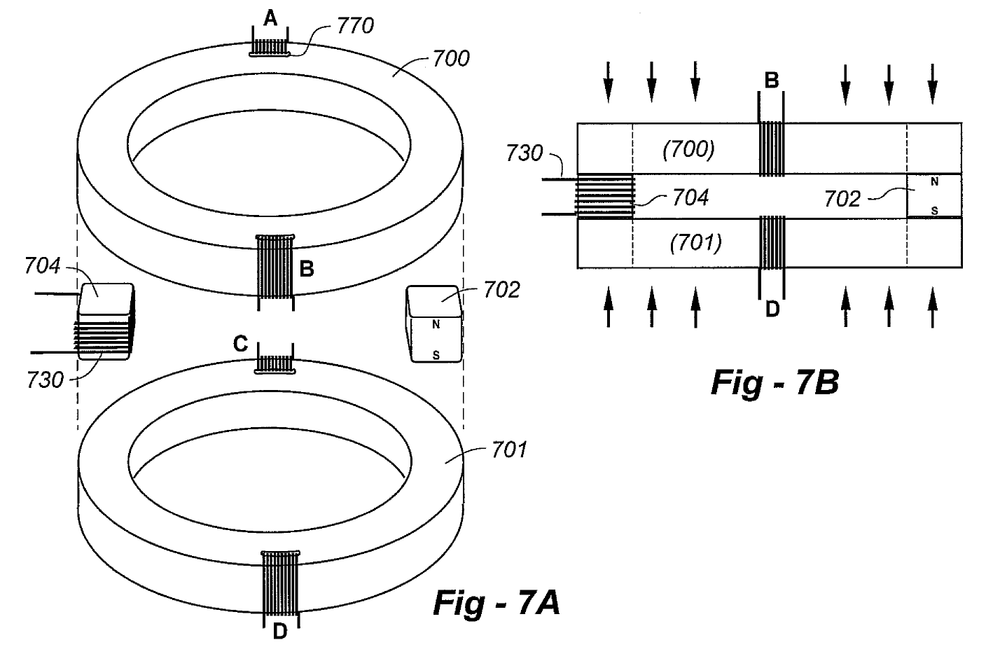

FIG. 7A depicts a preferred construction of the apparatus depicted in FIGS. 4, 6A and 6B. Loops 400, 401 are implemented as complete toroids 700, 701. This is important, since preferred high-performance magnetic materials are currently available in regular shapes of this kind. Note that, in this case, curved slots such as 770 are formed through the sides of each toroid to implement flux switches A-D. The magnetizable member in this embodiment is implemented with a block of material 704, preferably the same high-performance magnetic material used to construct loops 400, 401. Permanent magnet 702, shown at 702, preferably has the same length as block 704, enabling the various constituent parts to be held together with compression, shown in FIG. 7B.

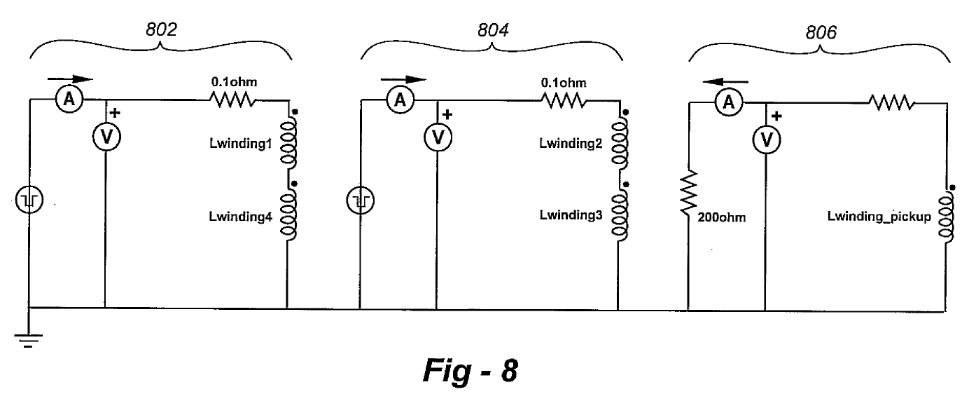

FIG. 8 is a simplified schematic diagram of components used to simulate the apparatus of FIGS. 4, 6A and 6B. The circuit used to drive switches A-D (Lwinding1, 2) is shown at 802. The circuit used to drive switches B-C (Lwinding2, 3) is shown at 802, and the equivalent circuit associated with the output is shown at 806. Lwinding_pickup is the coil wound around the magnetizable member. Note that the switches operated simultaneously are simply connected in series, which is also possible with the various physical implementations. Each input circuit uses a current generator, whereas the output circuit uses an ammeter. All circuits include a voltmeter.

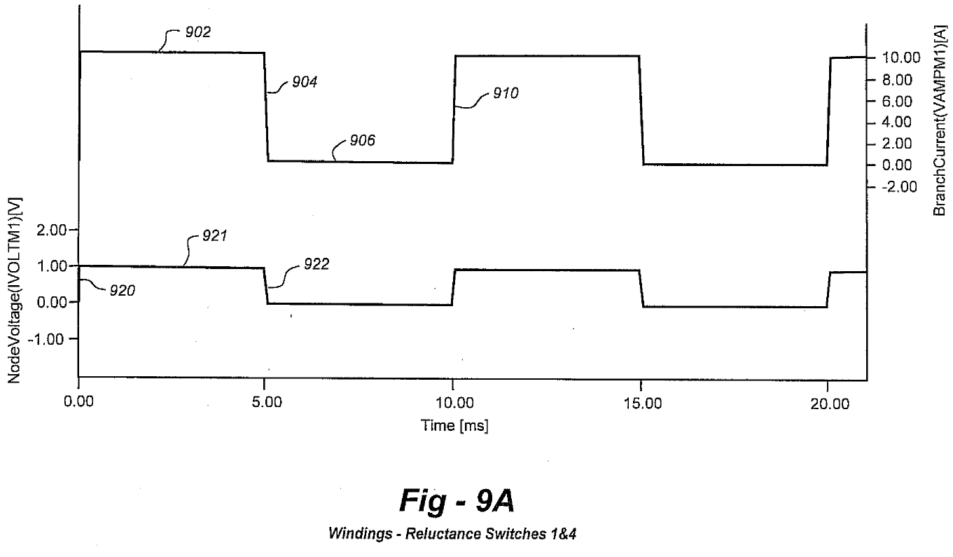

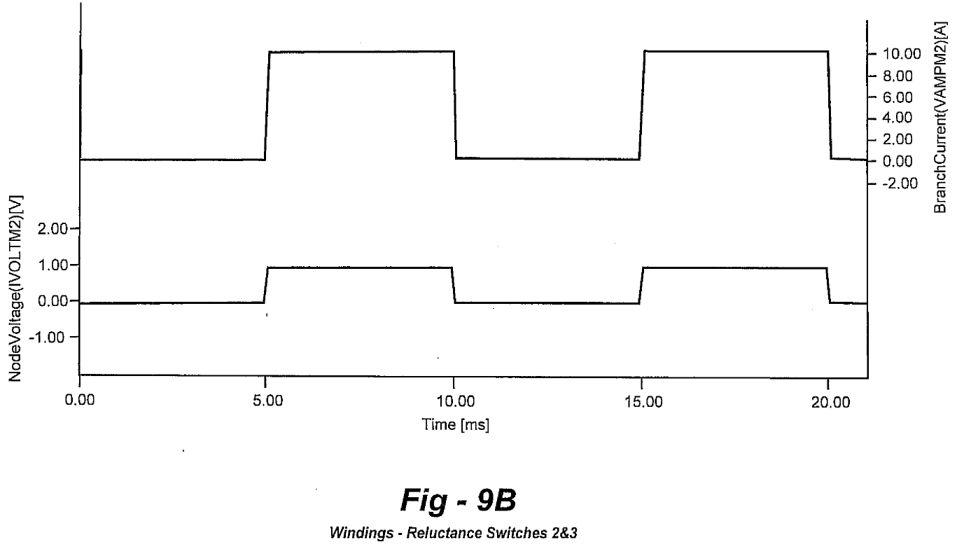

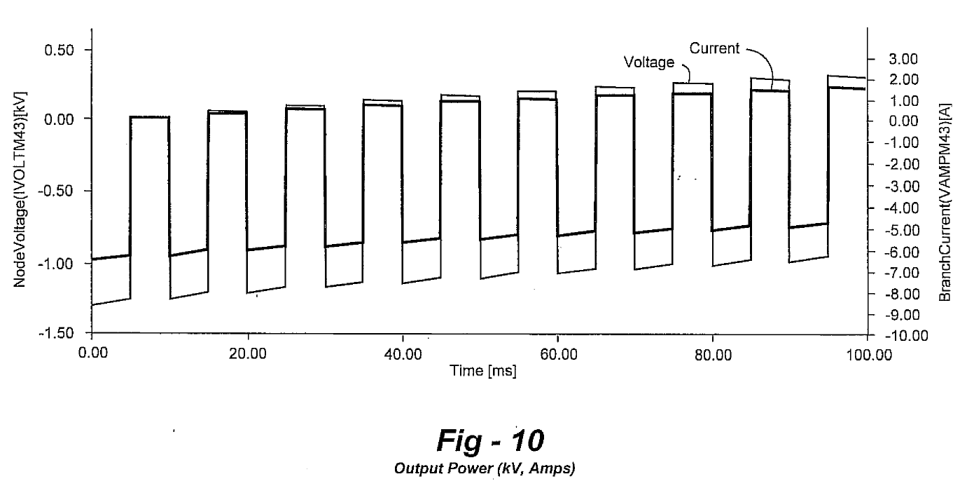

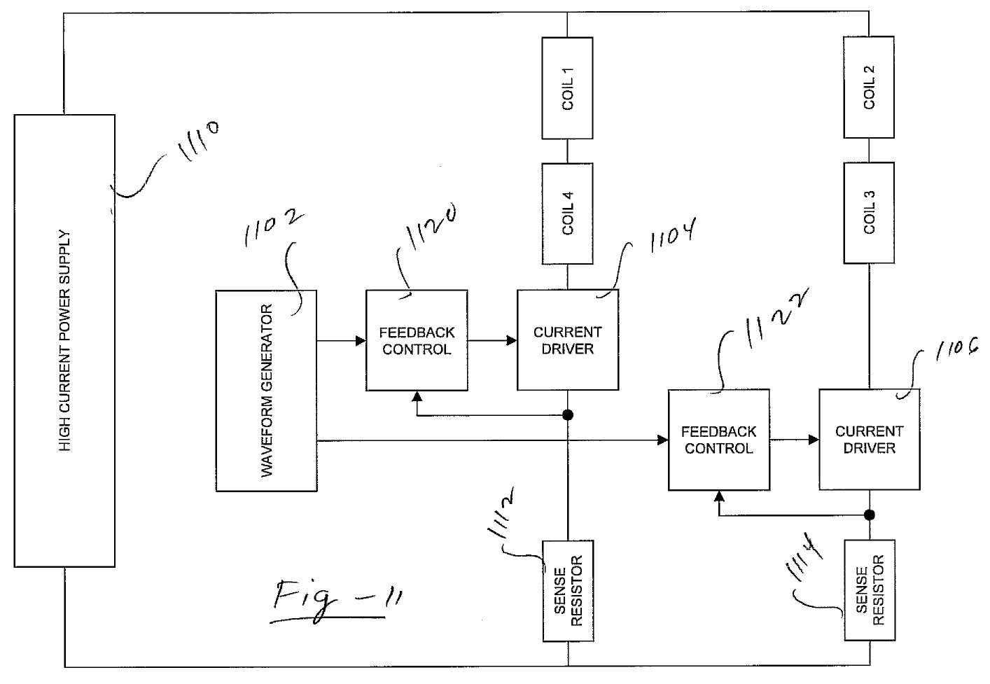

While the applied current to the flux switches may be AC, steady-state DC or pulsed DC, it has been found through simulation that pulsed current achieves a vastly superior result. FIG. 9A is a diagram that shows the current delivered to the flux switches in the simulation. Current is shown at 902, 904, 906, 910, while voltage is shown at 920, 921, 922. Note that the drive voltage settles down to approximately 1 volt per cycle at a consistent peak Amperage of about 10 Amperes. FIG. 9B is a diagram that shows the current delivered to the other set of flux switches in the simulation. The corresponding output from the simulation is graphed in FIG. 10. Again, after initial variations, the output achieves a steady state of over +/−10 Amperes at over +/−1.5 kilovolts. Such a substantial power gain leads to the conclusion that at least a portion of the output may be used to drive the coils comprising the flux switches.

FIG. 11 is a block diagram of a controller applicable to the invention. A waveform generator provides appropriate current drive to current drivers 1104, 1106. Waveform generator is preferable a programmable device allowing for variation in drive requirements. Each current driver 1104, 1106 couples the waveforms from generator 1102 to a pair of flux switch coils 1,4 and 2,3, energizing the coils with energy from high-current supply 1110. The current to each pair of coils is sensed by resistors 1112, 1114, facilitating feedback control via blocks 1120, 1122, thereby providing for a more stable operation.

The following sections summarize some of the important characteristics of the preferred embodiments.

In terms of materials, the apparatus benefits from the use of nanocrystalline material with a “Square” BH intrinsic curve, a high Br (remanence) which is about 80% of its Bs (saturation), a low Hc (coercivity), and a fast magnetic response time to saturation. An example is FineMet FT-3H from Hitachi of Japan, which has a Br of 1.0 Tesla, a Bs (saturation) of 1.21 Tesla, a time to saturation (Bs) of 2 usec, and an Hc of −0.6 amp-turns/meter.

Modern permanent magnets are used with a square BH intrinsic curve, a Br in the range of 1.0 Tesla or more, and high Hc in the range of −800,000 amp-turns/meter or more. An example is the NdFeB magnet from the German company VAC, which has a Br of 1.427 Tesla and an Hc of −1,079,000 amp-turns/meter.

An important consideration is the matching of the magnet to the nanocrystalline material, both in Tesla rating and in cross-sectional area. The magnet's Br should be below the Bs of the nanocrystalline material. If the magnet is too “strong” for the nanocrystalline material, this may cause the nanocrystalline material to saturate at the area of contact with the magnetic.

The current driving the reluctance switches in the prescribed 2×2 sequence should have a sharp rise in the leading edge (Tr) of each pulse with a pulse width (Pw) and Amperage value that are sustained until released at the end of the pulse width (Tf). The table below shows the effects of input current pulse rise times (Tr) on the output. These exists a narrow band of Tr, before which there is small power output, at which there are excellent power output and CoPs (coefficients of performance) in the range of 200 to 400 or greater, and after which there is no major increase in power output. The CoP of this device without the coupling circuit is defined as “Output power/Drive Power” for the switches.

| Tr | Output Power | Waveform Description |
|---|---|---|
| 1.0E−4 secs | 50 Watts | Spikes |
| 7.5E−5 | 50 Watts+ | Spikes with intermittent 30 |
| | | Kilowatt square waves |
| 5.0E−5 | 15 Kilowatts | Square waves after 3 cycles |
| 1.0E−5 | 15 Kilowatts | Square waves after 1 cycle |

Note:
The above data are for a dual toroid configuration using Finemet FT-3H, a permanent magnet of 1.2 Tesla, and a drive current of 7.0 Amps in the reluctance switches. The toroids have an ID of 200 mm, an OD of 80 mm, and a thickness of 30 mm. Each reluctance switch comprises 100 turns. The output has 40 Turns and feeds a 200 Ohm resistor.

To maximize output power, there should be a match between output coil turns and the resistive load. This relates to the L-R time constant.

In the preferred embodiments, four circuits are used to operate and control the apparatus: 1) Input Switching Circuit, 2) Output Conversion Circuit, 3) Coupling Circuit, and 4) Startup Circuit. The Coupling Circuit takes some of the output and uses it to power the Input Switching Circuit thereby making the device self-powering.

The invention may be used wherever there is a need or use for electrical power Further, the invention coupled to an electric motor via an intervening circuit and may be used in place of engines powered by combustion, heat, wind, and water. The invention's innate ability to power a resistive load permits it to be used to generate heat directly.

Uses of the invention include, and are not limited to, providing electrical power for the following;

| | | |
|---|---|---|
| Automobiles, | Light and EM wave | Electrical devices |
| Trucks, | amplification | Electrostatic devices |
| Buses, | Machinery | Electromagnetic devices |
| Mopeds, | Appliances | Satellites |
| Powered vehicles | Radio, TV | Space station |
| Trains | Communications | RADAR |
| Boats and ships | Electronic equipment | Cleansing of the air |
| Submarines | Phones and cell phones | Extracting water from air |
| Airplanes | Wristwatches and clocks | Wells |
| Drones | Artificial heart | Welding |
| Robots, robotic | Powered prosthetic limbs | Pumps |
| devices | Pacemakers | Purification, |
| Wheelchairs | Implants | Distillation, |
| Heaters | Hearing aids | Electrolytic breakdown of |
| Welding | Artificial eye | liquids |
| Homes, | Artificial limbs | Extracting metals and |
| Factories, | Body monitoring | minerals from seawater |
| Offices, | GPS | Refining and smelting |
| Institutions | Lasers | Colliders |
| Heating | Particle beam apparatus | MRIs |
| Cooling | Computers | Remote sensors |
| Lighting | | |

We claim:

1. An energy generator, comprising:
at least one permanent magnet generating flux;
a magnetizable member;
an electrical conductor wound around the member; and
a plurality of magnetic flux switches operative to sequentially reverse the flux from the magnet through the member, thereby inducing electricity in the electrical conductor.

2. The energy generator of claim 1, comprising:
first and second loops of magnetizable material;
the first loop having four segments in order A, 1, B, 2;
the second loop having four segments in order C, 3, D, 4;
the magnetizable member coupling segments 2 and 4;
the permanent magnet coupling segments 1 and 3, such that the flux from the magnet flows through segments A, B, C, D and the magnetizable member;
four magnetic flux switches, each controlling the flux through a respective one of the segments A, B, C, D; and
a controller operative to activate switches A-D and B-C in an alternating sequence, thereby reversing the flux through the segment and inducing electricity in the electrical conductor.

3. The energy generator of claim 2, wherein the loops and magnetizable member are composed of a nanocrystalline material exhibiting a substantially square BH intrinsic curve.

4. The energy generator of claim 2, wherein each magnetic flux switch is operative to add flux to the segment it controls, thereby magnetically saturating that segment when activated.

5. The energy generator of claim 2, wherein:
each segment has an aperture formed therethrough; and
each magnetic flux switch is implemented as a coil of wire wound through one of the apertures.

6. The energy generator of claim 2, wherein the controller is at least initially operative to activate the switches with electrical current spikes.

7. The energy generator of claim 2, wherein the first and second loops are toroids.

8. The energy generator of claim 2, wherein the first and second loops are spaced apart from one another, with A opposing C, 1 opposing 3, B opposing D and 2 opposing 4.

9. The energy generator of claim 2, wherein the first and second loops intersect to form the magnetizable member.

10. The energy generator of claim 2, wherein the flux flowing through each segment A, B, C, D is substantially half of that flowing through the magnetizable member prior to switch activation.
